(19) United States
(12) Patent Application Publication
(10) Pub. No.: US 2009/0033784 A1
(43) Pub. Date: Feb. 5, 2009

(54) SOLID-STATE IMAGING DEVICE AND IMAGING APPARATUS

(76) Inventor: Takashi Machida, Kurokawa-gun (JP)

Correspondence Address: BIRCH STEWART KOLASCH & BIRCH, PO BOX 747, FALLS CHURCH, VA, 22040-0747, US

(21) Appl. No.: 12/177,949

(22) Filed: Jul. 23, 2008

(30) Foreign Application Priority Data
Jul. 30, 2007 (JP) P2007-197300

(51) Int. Cl. H04N 5/335

(52) U.S. Cl. 348/311; 348/E05.091

(57) ABSTRACT

A solid-state imaging device is provided and includes: a plurality of pairs of photoelectric conversion elements, each pair including a first photoelectric conversion element and a second photoelectric conversion element which are adjacent to each other; a charge transfer path that is disposed adjacently to the first photoelectric conversion element and that transfers in a first direction an electric charge stored in the first photoelectric conversion element; a first charge reading section that is disposed between the charge transfer path and the first photoelectric conversion element and that reads the electric charge stored in the first photoelectric conversion element to the charge transfer path; and a second charge reading section that is disposed between the first photoelectric conversion element and the second photoelectric conversion element and that reads an electric charge stored in the second photoelectric conversion element to the first photoelectric conversion element.

This application is based on and claims priority under 35 U.S.C. §119 from Japanese Patent Application No. 2007-197300 filed Jul. 30, 2007, the entire disclosure of which is herein incorporated by reference.

### BACKGROUND OF THE INVENTION

1. Field of the Invention

The present invention relates to a solid-state imaging device having a photoelectric conversion element, an electric charge transfer path for transferring an electric charge generated in the photoelectric conversion element and an electric charge reading section for reading the electric charge to the electric charge transfer path from the photoelectric conversion element.

2. Description of Related Art

JP-A-08-009267 discloses a solid-state imaging device having a photoelectric conversion element and a vertical electric charge transfer path for transferring an electric charge generated in the photoelectric conversion element in a vertical direction. This solid-state imaging device includes one vertical electric charge transfer path relative to two photoelectric conversion element columns composed of a plurality of photoelectric conversion elements arranged in the vertical direction. The vertical electric charge transfer path corresponding to the two photoelectric conversion element columns is arranged between the two photoelectric conversion element columns. According to such a configuration, the number of the vertical electric charge transfer paths can be made to be half as many as that of an ordinary solid-state imaging device, and even when the number of pixels is increased, the width of the vertical electric charge transfer path does not need to be reduced or the area of the photoelectric conversion element does not need to be decreased. Thus, an electric charge transfer efficiency or a sensitivity can be maintained.

In the solid-state imaging device disclosed in JP-A-08-009267, the two photoelectric conversion elements sandwiching the vertical electric charge transfer path therebetween serve to detect the same color and the electric charges generated in the two photoelectric conversion elements can be mixed to generate image data. However, when such a mixing operation is carried out, the two mixed electric charges are obtained from the two photoelectric conversion elements located at positions separated from each other and sandwiching the vertical electric charge transfer path therebetween. Therefore, the electric charges at sampling points separate in distance are mixed together, so that the quality of an image is deteriorated.

### SUMMARY OF THE INVENTION

An object of the invention is to provide a solid-state imaging device that can maintain a charge transfer efficiency or a sensitivity even when the number of pixels is increased and can form an image of a high image quality even when electric charges are mixed together.

According to an aspect of the invention, there is provided a solid-state imaging device including: a plurality of pairs of photoelectric conversion elements, each pair including a first photoelectric conversion element and a second photoelectric conversion element which are adjacent to each other; a charge transfer path that is disposed adjacently to the first photoelectric conversion element and that transfers in a first direction an electric charge stored in the first photoelectric conversion element; a first charge reading section that is disposed between the charge transfer path and the first photoelectric conversion element and that reads the electric charge stored in the first photoelectric conversion element to the charge transfer path; and a second charge reading section that is disposed between the first photoelectric conversion element and the second photoelectric conversion element and that reads an electric charge stored in the second photoelectric conversion element to the first photoelectric conversion element.

In the solid-state imaging device, the plurality of pairs of photoelectric conversion elements may be arranged in such a way that a first photoelectric conversion element column including a plurality of first photoelectric conversion elements arranged in the first direction and a second photoelectric conversion element column including a plurality of second photoelectric conversion elements disposed adjacent to the respective first photoelectric conversion elements and arranged in the first direction are alternately arranged in a second direction perpendicular to the first direction. The first photoelectric conversion element column and the second electric conversion element column which are continuously arranged in the second direction constitute a set of element column. The electric charge transfer path may be disposed correspondingly in a side part of the set of element column.

In the solid-state imaging device, the second photoelectric conversion element may be arranged at a position shifted from a position of the first photoelectric conversion element to a direction intersecting each of the first direction and the second direction.

In the solid-state imaging device, the plurality of pairs of photoelectric conversion elements may be arranged in such a way that a first photoelectric conversion element column including a plurality of first photoelectric conversion elements arranged in the first direction and a second photoelectric conversion element column including a plurality of second photoelectric conversion elements disposed adjacent to the respective first photoelectric conversion elements and arranged in the first direction are alternately arranged in a second direction perpendicular to the first direction. Four photoelectric conversion element columns which include two first photoelectric conversion element columns and two second electric conversion element columns and which are continuously arranged in the second direction constitute a set of element column. The electric charge transfer path may be disposed correspondingly to the set of element column and between the first photoelectric conversion element column and the second photoelectric conversion element column which are not the first photoelectric conversion element column and the second photoelectric conversion element column at both ends of the set of element column.

In the solid-state imaging device, when a position of the first photoelectric conversion element in each pair of photoelectric conversion elements included in the four photoelectric conversion element columns constituting the set of element column is set to a reference position, the second photoelectric conversion element of a pair of photoelectric conversion elements located in one side of the electric charge transfer path may be disposed at a position shifted from the reference position in a direction different from that of the second photoelectric conversion element of a pair of photoelectric conversion elements located in the other side of the electric charge transfer path.

In the solid-state imaging device, the direction from the reference position with respect to the second photoelectric conversion element of the pair of photoelectric conversion elements located in the one side of the electric charge transfer path may be perpendicular to the direction from the reference position with respect to the second photoelectric conversion element of the pair of photoelectric conversion elements located in the other side of the electric charge transfer path.

In the solid-state imaging device, the second photoelectric conversion element may have a potential shallower than that of the first photoelectric conversion element.

In the solid-state imaging device, the second photoelectric conversion element may have an area smaller than that of the first photoelectric conversion element.

In the solid-state imaging device, the first and second photoelectric conversion elements may have different sensitivity for detecting light.

In the solid-state imaging device, the first photoelectric conversion element may detect light having the same wavelength area as that of light detected by the second photoelectric conversion element.

The solid-state imaging device may further include a plurality of electrodes arranged above the second charge reading section and in a direction where the pair of photoelectric conversion elements are arranged, in which a voltage can be independently applied to each of the plurality of electrodes.

According to an aspect of the invention, there is provided an imaging apparatus including: the solid-state imaging device; and a voltage applying unit that applies a voltage to the plurality of electrodes. The voltage applying unit shifts a timing for applying the voltage to the plurality of electrodes to move an electric charge from the second photoelectric conversion element to the first photoelectric conversion element.

In the imaging apparatus, the voltage applying unit may apply a lower voltage to an electrode of the plurality of electrodes as the electrode is nearer to the second photoelectric conversion element.

According to an aspect of the invention, there is provided an imaging apparatus including: the solid-state imaging device; and a voltage applying unit that applies a voltage to the plurality of electrodes. The voltage applying unit applies a lower voltage to an electrode of the plurality of electrodes as the electrode is nearer to the second photoelectric conversion element.

According to an aspect of the invention, there is provided an imaging apparatus of including the solid-state imaging device.

### BRIEF DESCRIPTION OF THE DRAWINGS

The features of the invention will appear more fully upon consideration of the exemplary embodiments of the inventions, which are schematically set forth in the drawings, in which:

FIG. 1 is a partly enlarged schematic view showing a schematic structure of a solid-state imaging device of a first exemplary embodiment of the present invention;

FIG. 2 is a diagram showing in detail a structure of a part in the vicinity of a pair of photoelectric conversion elements including a photoelectric conversion element shown by “R” in FIG. 1 and a photoelectric conversion element shown by “r” paired therewith;

FIG. 3 is a diagram showing a potential in a section taken along a line III-III shown in FIG. 2;

FIG. 4 is a diagram showing a schematic structure of a digital camera as an exemplary embodiment of an imaging apparatus on which the solid-state imaging device shown in FIG. 1 is mounted;

FIG. 5 is a partly enlarged schematic view showing a schematic structure of a solid-state imaging device of a second exemplary embodiment of the present invention;

FIG. 6 is a diagram showing in detail a structure of a part in the vicinity of a pair of photoelectric conversion elements including a photoelectric conversion element shown by “G” and a photoelectric conversion element shown by “g” paired therewith that are located in the left side of a vertical electric charge transfer path, among photoelectric conversion elements constituting a set of element columns shown in FIG. 5;

FIG. 7 is a diagram showing in detail the structure of a part in the vicinity of a pair of photoelectric conversion elements including a photoelectric conversion element shown by “R” and a photoelectric conversion element shown by “r” paired therewith that are located in the right side of the vertical electric charge transfer path 3, among photoelectric conversion elements constituting a set of element columns shown in FIG. 5.

FIG. 8 is a partly enlarged schematic view showing a schematic structure of a solid-state imaging device of a third exemplary embodiment of the present invention;

FIG. 9A is a sectional schematic view taken along a line IXA-IXA shown in FIG. 8 and FIG. 9B is a sectional schematic view taken along a line IXB-IXB shown in FIG. 8;

FIG. 10 is a partly enlarged schematic view showing a schematic structure of a solid-state imaging device of a fourth exemplary embodiment of the present invention; and

FIG. 11A is a sectional schematic view taken along a line XIA-XIA shown in FIG. 10 and FIG. 11B is a sectional schematic view taken along a line XIB-XIB shown in FIG. 10.

### DETAILED DESCRIPTION OF THE EXEMPLARY EMBODIMENTS

According to an exemplary embodiment of the present invention, a solid-state imaging device can be provided that can maintain the electric charge transfer efficiency or the sensitivity even when the number of pixels is increased and can form the image of a high image quality even when the electric charges are mixed together.

Now, exemplary embodiments of the present invention will be described below by referring to the drawings.

### First Embodiment

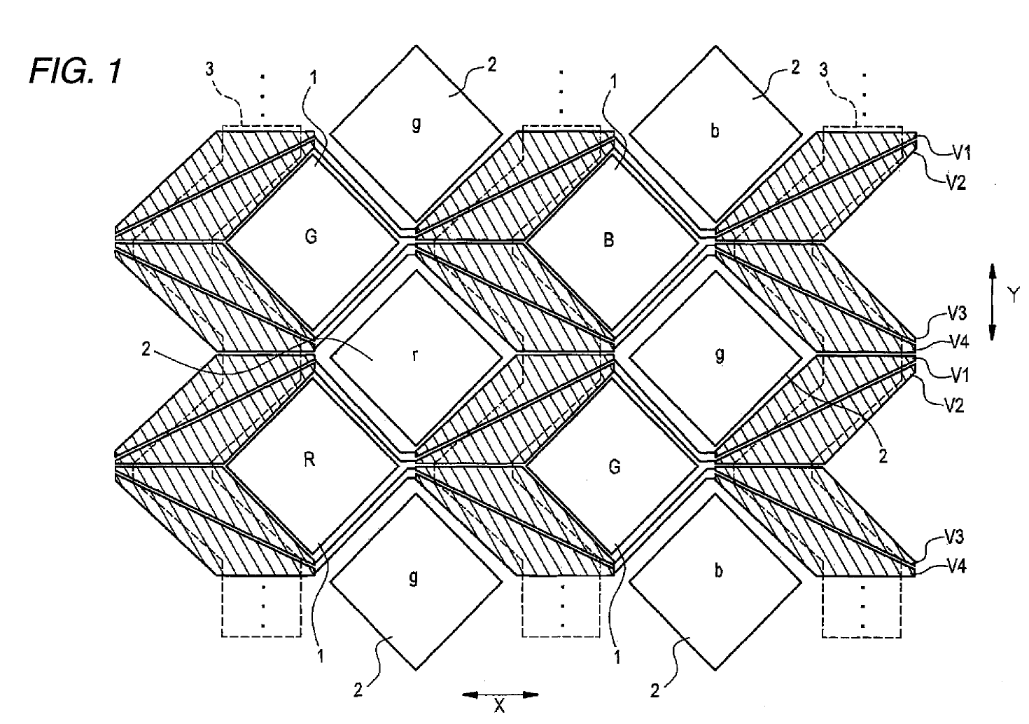

FIG. 1 is a partly enlarged schematic view showing a schematic structure of a solid-state imaging device of a first exemplary embodiment of the present invention.

The solid-state imaging device shown in FIG. 1 includes: a plurality of photoelectric conversion elements 1 arranged in a vertical direction Y and a horizontal direction X perpendicular to the vertical direction in the form of a lattice; and photoelectric conversion elements 2 arranged correspondingly to and adjacently to the respective photoelectric conversion elements 1 in the same directions as those of the photoelectric conversion elements 1. The photoelectric conversion element 2 is, when the position of the photoelectric conversion element 1 corresponding thereto is set as a reference position, arranged at a position shifted in a direction intersecting the vertical direction Y and the horizontal direction X respectively at an angle of 45° (an obliquely rightward and upward direction in the drawing) from the reference position. A pair of photoelectric conversion elements defined is formed by the photoelectric conversion element 1 and the photoelectric conversion element 2 adjacent thereto in the obliquely rightward and upward direction.

The plurality of photoelectric conversion elements 1 include three kinds of photoelectric conversion elements including an R photoelectric conversion element (in FIG. 1, designated by a character “R”) for detecting light in a wavelength area of red (R) of incident light, a G photoelectric conversion element (in FIG. 1, designated by a character “G”) for detecting light in a wavelength area of green (G) of the incident light, and a B photoelectric conversion element (in FIG. 1, designated by a character “B”) for detecting light in a wavelength area of blue (B) of the incident light. The plurality of photoelectric conversion elements 1 are constructed in such a way that a GB photoelectric conversion element row in which the G photoelectric conversion element and the B photoelectric conversion element are alternately arranged in the horizontal direction X in this order and an RG photoelectric conversion element row in which the R photoelectric conversion element and the G conversion photoelectric conversion element are alternately arranged in the horizontal direction X in this order are alternately arranged in the vertical direction Y.

The photoelectric conversion elements 2 detect the lights of the same wavelength areas as those of the photoelectric conversion elements 1 respectively corresponding thereto and include three kinds of photoelectric conversion elements having an R photoelectric conversion element (in FIG. 1, designated by a character “r”) for detecting a light in the wavelength area of R of the incident lights, a G photoelectric conversion element (in FIG. 1, designated by a character “g”) for detecting a light in the wavelength area of G of the incident lights and a B photoelectric conversion element (in FIG. 1, designated by a character “b”) for detecting a light in the wavelength area of B of the incident lights. The plurality of photoelectric conversion elements 2 are constructed in such a way that a gb photoelectric conversion element row in which the G photoelectric conversion element and the B photoelectric conversion element are alternately arranged in the horizontal direction X in this order and an rg photoelectric conversion element row in which the R photoelectric conversion element and the G conversion photoelectric conversion element are alternately arranged in the horizontal direction X in this order are alternately arranged in the vertical direction Y.

The photoelectric conversion element 1 and the photoelectric conversion element 2 have different detecting sensitivities (sensitivities for detecting light). For instance, the detecting sensitivity of the photoelectric conversion element 2 is higher than that of the photoelectric conversion element 1. In order to change the detecting sensitivity of the photoelectric conversion element, the area of a light receiving surface of the photoelectric conversion element may be changed, a light converging area may be changed by a micro lens provided above the photoelectric conversion element or an exposure time may be changed between the two photoelectric conversion elements. Since these methods are well known, an explanation thereof is omitted. In this embodiment, the area of the photoelectric conversion element 1 is made to be smaller than the area of the photoelectric conversion element 2 to provide a sensitivity difference between the photoelectric conversion element 1 and the photoelectric conversion element 2. In the drawings, the area of the photoelectric conversion element 1 is shown to be the same as the area of the photoelectric conversion element 2.

In this specification, the detecting sensitivity of a photoelectric conversion element indicates characteristics showing how much a signal can be taken out from the photoelectric conversion element when a certain quantity of light is incident on the photoelectric conversion element. That is, a definition may be made that when the same light quantity of light is incident on the photoelectric conversion elements, the photoelectric conversion element whose detecting sensitivity is relatively higher has characteristics that a quantity of the signal to be taken out is larger than that of the photoelectric conversion element whose detecting sensitivity is relatively lower. Since the photoelectric conversion element having the high sensitivity can obtain a large quantity of the signal by a small quantity of light, this photoelectric conversion element is most suitable for shooting an object to be shot with low illumination intensity. However, when a large quantity of light is incident, since the signal is immediately saturated, the photoelectric conversion element having the high sensitivity is not suitable for shooting an object to be shot with high illumination intensity. Further, since the photoelectric conversion element having the low sensitivity cannot obtain a large quantity of the signal even when a large quantity of light is incident, this photoelectric conversion element is most suitable for shooting the object to be shot with the high illumination intensity. However, when a small quantity of light is incident, a quantity of the signal to be obtained is too small, so that the photoelectric conversion element having the low sensitivity is not suitable for shooting the object to be shot with the low illumination intensity.

It may be said that the arrangement of the photoelectric conversion elements included in the solid-state imaging device shown in FIG. 1 is constructed in such a way that a first photoelectric conversion element column including a plurality of photoelectric conversion elements 1 arranged in the vertical direction Y and a second photoelectric conversion element column including a plurality of photoelectric conversion elements 2 arranged in the vertical direction Y are alternately arranged in the horizontal direction X. Otherwise, it may be said that the arrangement of the photoelectric conversion elements is constructed in such a way that a first photoelectric conversion element row including a plurality of photoelectric conversion elements 1 arranged in the horizontal direction X and a second photoelectric conversion element row including a plurality of photoelectric conversion elements 2 arranged in the horizontal direction X are alternately arranged in the vertical direction Y.

In the side part (here, the right side part of the second photoelectric conversion element column) in a set of element columns including the first photoelectric conversion element column and the second photoelectric conversion element column which are continuously arranged in the horizontal direction X, a vertical electric charge transfer path 3 is provided for transferring electric charges stored in the photoelectric conversion elements 2 constituting the second photoelectric conversion element column in the vertical direction Y correspondingly to the set of element columns.

Above the vertical electric charge transfer path 3, a plurality of sets of electrodes in which a transfer electrode V1, a transfer electrode V2, a transfer electrode V3 and a transfer electrode V4 are arranged in order in the vertical direction Y are arranged and formed in the vertical direction Y. Four transfer electrodes V1 to V4 are provided correspondingly to one photoelectric conversion element 2. The transfer electrodes V1 to V4 each are arranged in a zigzag manner toward the horizontal direction X between the first photoelectric conversion element row and the second photoelectric conversion element row. Specifically, in the lower side part of the second photoelectric conversion element row, the transfer electrode V1 and the transfer electrode V2 are arranged in order from the second photoelectric conversion element row side between the second photoelectric conversion element row and the adjacent first photoelectric conversion element row. In the upper side part of the second photoelectric conversion element row, the transfer electrode V4 and the transfer electrode V3 are arranged in order from the second photoelectric conversion element row side between the second photoelectric conversion element row and the adjacent first photoelectric conversion element row. To each of the transfer electrodes V1 to V4, are applied transfer pulses for transferring the electric charges read to the vertical electric charge transfer path 3 in the vertical direction Y.

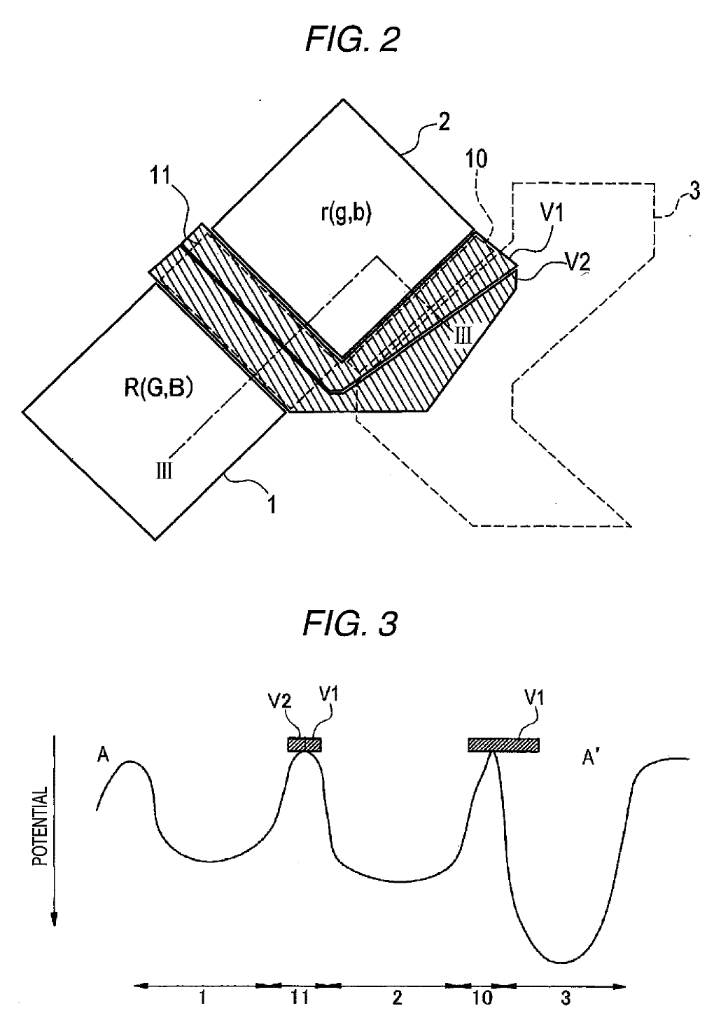

FIG. 2 is a diagram showing in detail the structure of a part in the vicinity of the pair of photoelectric conversion elements including the photoelectric conversion element 1 shown by “R” in FIG. 1 and the photoelectric conversion element 2 shown by “r” paired therewith. The structure of a part in the vicinity of the pair of photoelectric conversion elements including the photoelectric conversion element 1 shown by “G” in FIG. 1 and the photoelectric conversion element 2 shown by “g” paired therewith and the structure of a part in the vicinity of the pair of photoelectric conversion elements including the photoelectric conversion element 1 shown by “B” in FIG. 1 and the photoelectric conversion element 2 shown by “b” paired therewith are the same as the structure shown in FIG. 2.

As shown in FIG. 2, between the photoelectric conversion element 1 and the photoelectric conversion element 2 paired therewith, an electric charge reading section 11 is provided for reading the electric charge stored in the photoelectric conversion element 1 to the photoelectric conversion element 2. Further, between the lower side part of the photoelectric conversion element 2 and the vertical electric charge transfer path 3, an electric charge reading section 10 is formed for reading the electric charge stored in the photoelectric conversion element 2 to the vertical electric charge transfer path 3. The transfer electrode V1 is formed to cover the entire part of the electric charge reading section 10 and a part of the electric charge reading section 11. The transfer electrode V2 is formed to cover a part except a part of the electric charge reading section 11.

FIG. 3 is a diagram showing a potential in a section taken along a line III-III shown in FIG. 2. Since the area of the photoelectric conversion element 1 is smaller than that of the photoelectric conversion element 2, the potential of the photoelectric conversion element 1 is shallower than that of the photoelectric conversion element 2, as shown in FIG. 3. Above the electric charge reading section 11, the transfer electrode V2 and the transfer electrode V1 are arranged in the direction where the photoelectric conversion element 1 and the photoelectric conversion element 2 are arranged. The transfer electrodes V1 and V2 also function as reading gates for reading the electric charges. Above the electric charge reading section 10, the transfer electrode V1 is formed and this transfer electrode V1 functions also as the reading gate for reading the electric charge.

Though not shown in FIG. 1, in the solid-state imaging device of this embodiment, a horizontal electric charge transfer path is provided at the terminal end of the vertical electric charge transfer path 3 to transfer the electric charge transferred in the vertical electric charge transfer path 3 in the horizontal direction X. At the terminal end of the horizontal electric charge transfer path, an output amplifier is provided for converting the electric charge transferred in the horizontal electric charge transfer path to a voltage signal and outputting the voltage signal.

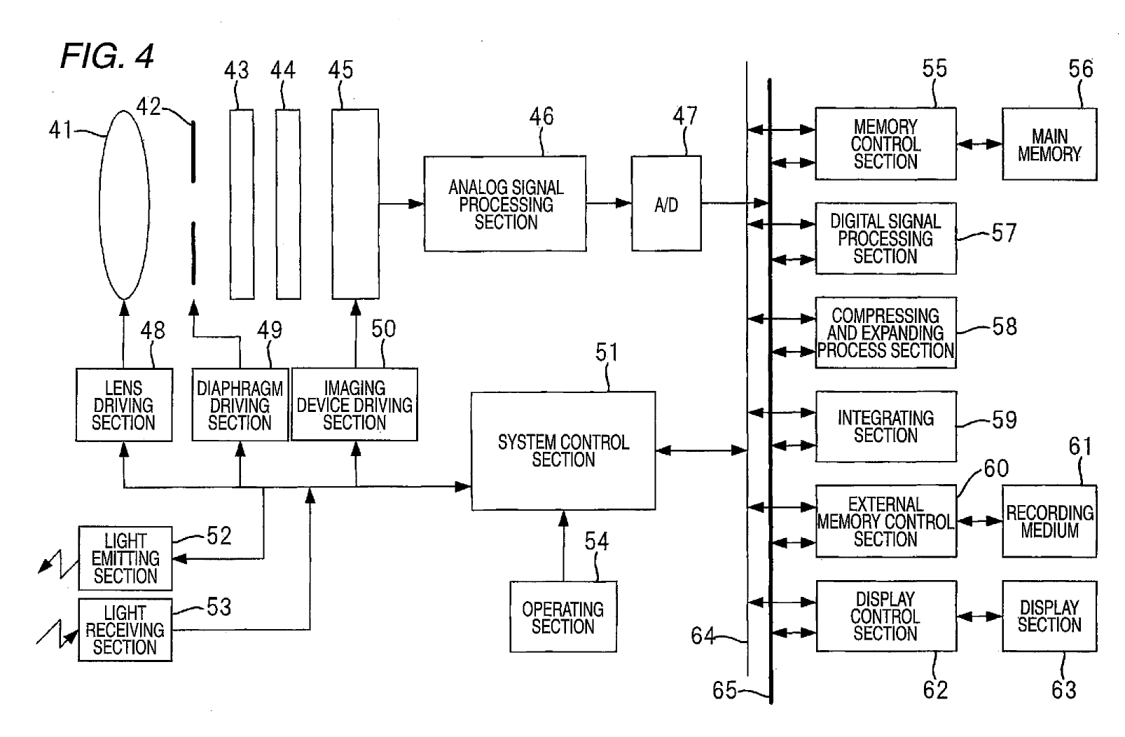

FIG. 4 is a diagram showing a schematic structure of a digital camera as an exemplary embodiment of an imaging apparatus on which the solid-state imaging device shown in FIG. 1 is mounted.

An imaging system of the digital camera shown in FIG. 4 includes a taking lens 41, a solid-state imaging device 45 having the structure shown in FIG. 1, an aperture diaphragm 42, an infrared ray cut filter 43 and an optical low-pass filter 44 provided between the shooting lens 41 and the solid-state imaging device 45.

A system control section 51 for generally controlling the entire part of an electric control system of the digital camera controls a flash light emitting section 52 and a light receiving section 53, controls a lens driving section 48 to adjust the position of the taking lens 41 to a focusing position or adjust a zoom and controls an amount of aperture of the aperture diaphragm 42 through a diaphragm driving section 49 to adjust an amount of exposure.

Further, the system control section 51 drives the solid-state imaging device 45 through an imaging device driving section 50 to output an image of the object to be shot through the talking lens 41 as a color signal. To the system control section 51, an instruction signal from a user is inputted through an operating section 54.

The electric control system of the digital camera further includes an analog signal processing section 46 connected to the output of the solid-state imaging device 45 to carry out an analog signal process such as a correlative double sampling process and an A/D converting circuit 47 for converting the color signals of RGB outputted from the analog signal processing section 46 into digital signals. These sections are controlled by the system control section 51.

Further, the electric control system of the digital camera includes a main memory 56, a memory control section 55 connected to the main memory 56, a digital signal processing section 57 for carrying out an interpolating calculation or a gamma correcting calculation and an RGB/YC converting process to generate image data, a compressing and expanding process section 58 for compressing the image data generated in the digital signal processing section 57 to a JPEG form or expanding the compressed image data, an integrating section 59 for integrating photometric data to obtain a gain of a white balance correction carried out by the digital signal processing section 57, an external memory control section 60 to which a detachable recording medium 61 is connected and a display control section 62 to which a liquid crystal display section 63 mounted on a back surface of the camera is connected. These members are mutually connected together by a control bus 64 and a data bus 65 and controlled by a command from the system control section 51.

The imaging element driving section 50 drives the solid-state imaging device by at least two driving modes including: a single reading mode that a reading pulse is applied only to the transfer electrode V1 to read the electric charge only from the photoelectric conversion element 2, and then, the transfer pulses are supplied to the transfer electrodes V1 to V4 to transfer the electric charge; and a mixed reading mode that the reading pulses are applied to the transfer electrode V1 and the transfer electrode V2 to mix and read the electric charge stored in the photoelectric conversion element 1 and the electric charge stored in the photoelectric conversion element 2, and then, the transfer pulses are supplied to the transfer electrodes V1 to V4 to transfer the mixed electric charges.

Now, an operation of the solid-state imaging device will be described below.

### (Single Reading Mode)

When the reading pulse is applied to the transfer electrode V1 by the imaging device driving section 50, potential barriers formed below the transfer electrode V1 by the electric charge reading sections 10 and 11 disappear. Since the potential barrier formed by the electric charge reading section 11 disappears only below the transfer electrode V1 and the potential barrier formed lower the transfer electrode V2 is kept, the electric charge stored in the photoelectric conversion element 1 is not moved to the photoelectric conversion element 2 and is held in the photoelectric conversion element 1. On the other hand, the electric charge stored in the photoelectric conversion element 2 is read to the vertical electric charge transfer path 3 via the electric charge reading section 10. After the electric charge is read from the photoelectric conversion element 2, four-phase transfer pulses are applied to the transfer electrodes V1 to V4 by the imaging device driving section 50 to transfer the electric charges in the vertical direction Y.

### (Mixed Reading Mode)

When the reading pulses are applied to the transfer electrode V1 and the transfer electrode V2 by the imaging device driving section 50, the potential barriers of the electric charge reading sections 10 and 11 below the transfer electrodes V1 and V2 disappear. Accordingly, the electric charge stored in the photoelectric conversion element 1 is read to the photoelectric conversion element 2 via the electric charge reading section 11 and mixed with the electric charge stored in the photoelectric conversion element 2. Then, the mixed electric charges of the electric charge read from the photoelectric conversion element 1 and the electric charge originally stored in the photoelectric conversion element 2 are read to the vertical electric charge transfer path 3 via the electric charge reading section 10. After the electric charges are read from the photoelectric conversion element 2, four-phase transfer pulses are applied to the transfer electrodes V1 to V4 by the imaging device driving section 50 to transfer the electric charges in the vertical direction Y.

As described above, according to the solid-state imaging device of this embodiment, the reading pulses are applied to the transfer electrodes V1 and V2, so that the electric charges stored in the photoelectric conversion element 1 and the photoelectric conversion element 2 corresponding thereto can be mixed together and read to the vertical electric charge transfer path 3. Since the detecting sensitivity of the photoelectric conversion element 2 is higher than the detecting sensitivity of the photoelectric conversion element 1, the electric charges are mixed as described above so that a dynamic range can be extended. Further, the photoelectric conversion element 1 is adjacent to the photoelectric conversion element 2 corresponding thereto through the electric charge reading section 11. Since the width of the electric charge reading section 11 can be made to be adequately smaller than that of the vertical transfer path 3, a distance between the photoelectric conversion element 1 and the photoelectric conversion element 2 is greatly smaller than a distance between the photoelectric conversion elements 1 or the photoelectric conversion elements 2 arranged in the horizontal direction X. That is, since the electric charges obtained in the two photoelectric conversion elements located at very close positions can be mixed together, the two electric charges scarcely having a shift in sampling points can be mixed together. Thus, an image of a good quality can be formed.

Further, in the solid-state imaging device of this embodiment, since the reading pulse is applied only to the transfer electrode V1, the electric charge can be read only from the photoelectric conversion element 2. When the electric charge is read only from the photoelectric conversion element 2, a time necessary for reading the electric charge can be shortened more than that necessary for reading the electric charges from the photoelectric conversion element 1 and the photoelectric conversion element 2. Therefore, the solid-state imaging device is driven in the single reading mode, so that a shooting time can be shortened. Thus, the solid-state imaging device of this embodiment is suitable for a shooting operation for executing an AF function or circumstances requiring a high speed operation such as a shooting operation of a moving image.

During the single reading mode, the electric charge is read only from the photoelectric conversion element 2. However, since the detecting sensitivity of the photoelectric conversion element 2 is relatively high, when the object to be shot is bright, it is estimated that an output is immediately saturated and a desired image cannot be obtained. Therefore, the detecting sensitivity difference between the photoelectric conversion element 1 and the photoelectric conversion element 2 is preferably adapted to be changed by an exposure time. In such a way, during the single reading mode, the detecting sensitivity of the photoelectric conversion element 2 can be adjusted depending on the object to be shot and the output can be prevented from being saturated.

Further, in the solid-state imaging device of this embodiment, as shown in FIG. 3, among the pair of photoelectric conversion elements including the photoelectric conversion element 1 and the photoelectric conversion element 2 corresponding thereto, the potential of the photoelectric conversion element 1 located at a position remote from the vertical electric charge transfer path 3 corresponding to the pair of photoelectric conversion elements is designed to be shallower than the potential of the photoelectric conversion element 2 located at a position near the vertical electric charge transfer path. Accordingly, a potential slope can be formed from the photoelectric conversion element 1 to the photoelectric conversion element 2 so that the electric charge can be smoothly read to the photoelectric conversion element 2 from the photoelectric conversion element 1.

In the solid-state imaging device of this embodiment, the area of the photoelectric conversion element 1 is made to be smaller than that of the photoelectric conversion element 2 to make the potential of the photoelectric conversion element 1 to be shallower than the potential of the photoelectric conversion element 2. However, a method for making the potential to be shallow is not limited thereto, and various known methods may be used.

In the structure of the solid-state imaging device of this embodiment, during the mixed reading mode, when the reading pulses are applied to the transfer electrode V1 and the transfer electrode V2 at the same time, an electric field concentration may arise to cause an inconvenience. Therefore, timings for applying the reading pulses to the transfer electrode V1 and the transfer electrode V2 may not be set to the same time and may be preferably shifted. For instance, a control is carried out that the reading pulse is initially applied to the transfer electrode V1, and then, after a time elapses, the reading pulse is applied to the transfer electrode V2. Thus, the electric field concentration can be avoided.

In order to avoid the electric field concentration, the voltage level of the reading pulse applied to the transfer electrode V2 may be set to be lower than that of the reading pulse applied to the transfer electrode V1.

Further, in the above description, the detecting sensitivity difference is provided between the photoelectric conversion element 1 and the photoelectric conversion element 2, however, the detecting sensitivity may not be provided.

### Second Embodiment

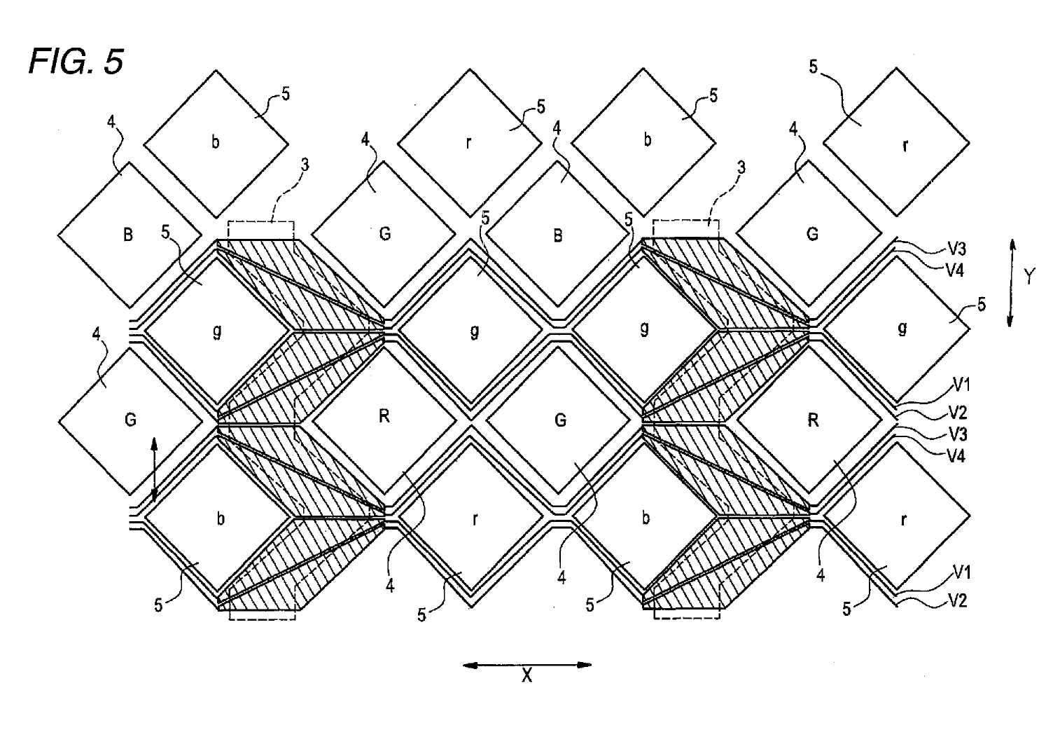

FIG. 5 is a partly enlarged schematic view showing a schematic structure of a solid-state imaging device of a second exemplary embodiment of the present invention.

The solid-state imaging device shown in FIG. 5 includes: a plurality of photoelectric conversion elements 4 arranged in a vertical direction Y and a horizontal direction X intersecting the vertical direction at right angles thereto in the form of a lattice; and photoelectric conversion elements 5 disposed correspondingly to and adjacently to the respective photoelectric conversion elements 1 in the same directions as those of the photoelectric conversion elements 1. The photoelectric conversion element 5 is, when the position of the photoelectric conversion element 4 corresponding thereto is set as a reference reference, arranged at a position shifted in a direction intersecting the vertical direction Y and the horizontal direction X respectively at an angle of 45° (an obliquely rightward and upward direction in the drawing) from the reference position.

It may be said that the arrangement of the photoelectric conversion elements included in the solid-state imaging device shown in FIG. 5 is constructed in such a way that a first photoelectric conversion element column including the plurality of photoelectric conversion elements 4 arranged in the vertical direction Y and a second photoelectric conversion element column including the plurality of photoelectric conversion elements 5 arranged in the vertical direction Y are alternately arranged in the horizontal direction X. Otherwise, it may be said that the arrangement of the photoelectric conversion elements is constructed in such a way that a first photoelectric conversion element row including the plurality of photoelectric conversion elements 4 arranged in the horizontal direction X and a second photoelectric conversion element row including the plurality of photoelectric conversion elements 5 arranged in the horizontal direction X are alternately arranged in the vertical direction Y.

In a set of element columns (first to fourth photoelectric conversion element columns counted from the left in FIG. 5) including two first photoelectric conversion element columns and two second photoelectric conversion element columns which are continuously arranged in the horizontal direction X, a vertical electric charge transfer path 3 is provided correspondingly to the set of element columns between the first photoelectric conversion element column and the second photoelectric conversion element column which are not at both ends of the set of element columns and is for transferring electric charges stored in the photoelectric conversion elements constituting the first photoelectric conversion element column and the second photoelectric conversion element column in the vertical direction Y.

The first photoelectric conversion element column of the four photoelectric conversion element columns constituting the set of element columns which is located in the left side of the vertical electric charge transfer path 3 is formed in such a way that a B photoelectric conversion element (in FIG. 5, designated by a character “B”) for detecting light of a wavelength area of B of incident light and a G photoelectric conversion element (in FIG. 5, designated by a character “G”) for detecting light of a wavelength area of G of the incident light are alternately arranged in this order in the vertical direction Y. Further, the photoelectric conversion element 5 that is adjacent obliquely rightward and upward to the photoelectric conversion element 4 constituting the first photoelectric conversion element column in the left side of the vertical electric charge transfer path 3 detects the light of the same wavelength area as that of the photoelectric conversion element 4. That is, the second photoelectric conversion element column that is located in the left side of the vertical electric charge transfer path 3 is formed in such a way that a B photoelectric conversion element (in FIG. 5, designated by a character “b”) for detecting light of the wavelength area of B of the incident light and a G photoelectric conversion element (in FIG. 5, designated by a character “g”) for detecting light of the wavelength area of G of the incident light are alternately arranged in this order in the vertical direction Y.

A pair of photoelectric conversion elements is formed by the photoelectric conversion element 4 located in the left side of the vertical electric charge transfer path 3 and the photoelectric conversion element 5 adjacent thereto in the obliquely rightward and upward direction among the four photoelectric conversion element columns constituting the set of element columns.

The first photoelectric conversion element column of the four photoelectric conversion element columns constituting the set of element columns which is located in the right side of the vertical electric charge transfer path 3 is formed in such a way that a G photoelectric conversion element (in FIG. 5, designated by a character “G”) for detecting light of the wavelength area of G of the incident light and an R photoelectric conversion element (in FIG. 5, designated by a character “R”) for detecting light of a wavelength area of R of the incident light are alternately arranged in this order in the vertical direction Y. Further, the photoelectric conversion element 5 that is adjacent obliquely rightward and downward to the photoelectric conversion element 4 forming the first photoelectric conversion element column in the right side of the vertical electric charge transfer path 3 detects the light of the same wavelength area as that of the photoelectric conversion element 4. That is, the second photoelectric conversion element column located in the right side of the vertical electric charge transfer path 3 is formed in such a way that an r photoelectric conversion element (in FIG. 5, designated by a character “r”) for detecting light of the wavelength area of R of the incident light and a G photoelectric conversion element (in FIG. 5, designated by a character “g”) for detecting light of the wavelength area of G of the incident light are alternately arranged in this order in the vertical direction Y.

A pair of photoelectric conversion elements is formed by the photoelectric conversion element 4 located in the right side of the vertical electric charge transfer path 3 and the photoelectric conversion element 5 adjacent thereto in the obliquely rightward and downward direction among the four photoelectric conversion element columns constituting the set of element columns. In such a way, a direction in which the photoelectric conversion element 5 of one pair of photoelectric conversion elements located in the right side of the vertical electric charge transfer path 3 is shifted from the photoelectric conversion element 4 is perpendicular to a direction in which the photoelectric conversion element 5 of another pair of the photoelectric conversion elements located in the left side of the vertical electric charge transfer path 3 is shifted from the photoelectric conversion element 4.

The photoelectric conversion element 4 and the photoelectric conversion element 5 have different detecting sensitivities. For instance, the detecting sensitivity of the photoelectric conversion element 4 is higher than that of the photoelectric conversion element 5.

Above the vertical electric charge transfer path 3, a plurality of sets of electrodes in which a transfer electrode V1, a transfer electrode V2, a transfer electrode V3 and a transfer electrode V4 are arranged in this order in the vertical direction Y are arranged and formed in the vertical direction Y. Four transfer electrodes V1 to V4 are provided correspondingly to one photoelectric conversion element 4 or photoelectric conversion element 5. The transfer electrodes V1 to V4 each are arranged in a zigzag manner toward the horizontal direction X between the first photoelectric conversion element row and the second photoelectric conversion element row. Specifically, in the lower side part of the second photoelectric conversion element row, the transfer electrode V1 and the transfer electrode V2 are arranged in order from the second photoelectric conversion element row side between the second photoelectric conversion element row and the adjacent first photoelectric conversion element row. Above the second photoelectric conversion element row, the transfer electrode V4 and the transfer electrode V3 are arranged in order from the second photoelectric conversion element row side between the second photoelectric conversion element row and the adjacent first photoelectric conversion element row. To the transfer electrodes V1 to V4, are applied transfer pulses for transferring the electric charges read to the vertical electric charge transfer path 3 in the vertical direction Y.

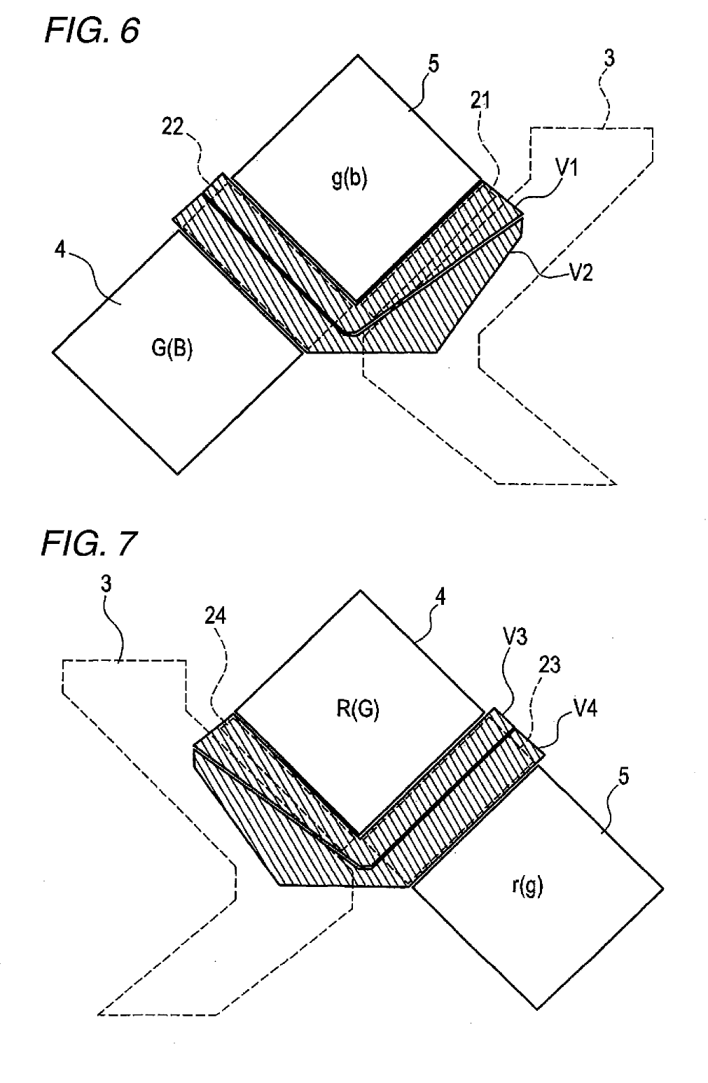

FIG. 6 is a diagram showing in detail the structure of a part in the vicinity of the pair of photoelectric conversion elements including the photoelectric conversion element 4 shown by “G” and the photoelectric conversion element 5 shown by “g” paired therewith that are located in the left side of the vertical electric charge transfer path 3 among the photoelectric conversion elements constituting the set of element columns shown in FIG. 5. The structure of a part in the vicinity of the pair of photoelectric conversion elements including the photoelectric conversion element 4 shown by “B” and the photoelectric conversion element 5 shown by “b” paired therewith that are located in the left side of the vertical electric charge transfer path 3 among the photoelectric conversion elements constituting the set of element columns shown in FIG. 5 is the same as the structure shown in FIG. 6.

As shown in FIG. 6, between the photoelectric conversion element 4 and the photoelectric conversion element 5 paired therewith, an electric charge reading section 22 is provided for reading the electric charge stored in the photoelectric conversion element 4 to the photoelectric conversion element 5. Further, between the lower side part of the photoelectric conversion element 5 and the vertical electric charge transfer path 3, an electric charge reading section 21 is formed for reading the electric charge stored in the photoelectric conversion element 5 to the vertical electric charge transfer path 3. The transfer electrode V1 is formed to cover the entire part of the electric charge reading section 21 and a part of the electric charge reading section 22. The transfer electrode V2 is formed to cover a part except a part of the electric charge reading section 22.

FIG. 7 is a diagram showing in detail the structure of a part in the vicinity of the pair of photoelectric conversion elements including the photoelectric conversion element 4 shown by “R” and the photoelectric conversion element 5 shown by “r” paired therewith that are located in the right side of the vertical electric charge transfer path 3 among the photoelectric conversion elements constituting the set of element columns shown in FIG. 5. The structure of a part in the vicinity of the pair of photoelectric conversion elements including the photoelectric conversion element 4 shown by “G” and the photoelectric conversion element 5 shown by “g” paired therewith that are located in the right side of the vertical electric charge transfer path 3 among the photoelectric conversion elements constituting the set of element columns shown in FIG. 5 is the same as the structure shown in FIG. 7.

As shown in FIG. 7, between the photoelectric conversion element 4 and the photoelectric conversion element 5 paired therewith, an electric charge reading section 23 is provided for reading the electric charge stored in the photoelectric conversion element 4 to the photoelectric conversion element 5. Further, between the lower side part of the photoelectric conversion element 4 and the vertical electric charge transfer path 3, an electric charge reading section 24 is formed for reading the electric charge stored in the photoelectric conversion element 4 to the vertical electric charge transfer path 3. The transfer electrode V3 is formed to cover the entire part of the electric charge reading section 24 and a part of the electric charge reading section 23. The transfer electrode V4 is formed to cover a part except a part of the electric charge reading section 23.

Though not shown in FIG. 5, in the solid-state imaging device of this embodiment, a horizontal electric charge transfer path is provided at the terminal end of the vertical electric charge transfer path 3 to transfer the electric charge transferred in the vertical electric charge transfer path 3 in the horizontal direction X. At the terminal end of the horizontal electric charge transfer path, an output amplifier is provided for converting the electric charge transferred in the horizontal electric charge transfer path to a voltage signal and outputting the voltage signal.

The structure of an imaging apparatus on which the solid-state imaging device of this embodiment is mounted is the same as the structure shown in FIG. 4. An imaging device driving section 50 of the imaging apparatus of this embodiment drives the solid-state imaging device by a mixed reading mode that reading pulses are applied to the transfer electrode V1 and the transfer electrode V2 to mix and read the electric charge stored in the photoelectric conversion element 4 and the electric charge stored in the photoelectric conversion element 5, then, transfer pulses are supplied to the transfer electrodes V1 to V4 to transfer the mixed electric charges, then, reading pulses are applied to the transfer electrode V3 and the transfer electrode V4 to mix and read the electric charge stored in the photoelectric conversion element 4 and the electric charge stored in the photoelectric conversion element 5, and then, transfer pulses are supplied to the transfer electrodes V1 to V4 to transfer the mixed electric charges.

Now, an operation of the solid-state imaging device will be described below.

Initially, the imaging device driving section 50 applies the reading pulses to the transfer electrode V1 and the transfer electrode V2. When the reading pulses are applied to the transfer electrode V1 and the transfer electrode V2, the potential barriers of the electric charge reading sections 21 and 22 below the transfer electrodes V1 and V2 disappear. Accordingly, the electric charge stored in the photoelectric conversion element 4 of the photoelectric conversion elements constituting the set of element columns which is located in the left side of the vertical electric charge transfer path 3 is read to the photoelectric conversion element 5 via the electric charge reading section 22 and mixed with the electric charge stored in the photoelectric conversion element 5. Then, the mixed electric charges of the electric charge read from the photoelectric conversion element 4 and the electric charge originally stored in the photoelectric conversion element 5 are read to the vertical electric charge transfer path 3 via the electric charge reading section 21. After the electric charges are read to the vertical electric charge transfer path 3, four-phase transfer pulses are applied to the transfer electrodes V1 to V4 by the imaging device driving section 50 to transfer the read electric charges in the vertical direction Y.

Then, the imaging device driving section 50 applies the reading pulses to the transfer electrode V3 and the transfer electrode V4. When the reading pulses are applied to the transfer electrode V3 and the transfer electrode V4, the potential barriers of the electric charge reading sections 23 and 24 below the transfer electrodes V3 and V4 disappear. Accordingly, the electric charge stored in the photoelectric conversion element 5 of the photoelectric conversion elements constituting the set of element columns which is located in the right side of the vertical electric charge transfer path 3 is read to the photoelectric conversion element 4 via the electric charge reading section 23 and mixed with the electric charge stored in the photoelectric conversion element 4. Then, the mixed electric charges of the electric charge read from the photoelectric conversion element 5 and the electric charge originally stored in the photoelectric conversion element 4 are read to the vertical electric charge transfer path 3 via the electric charge reading section 24. After the electric charges are read to the vertical electric charge transfer path 3, four-phase transfer pulses are applied to the transfer electrodes V1 to V4 by the imaging device driving section 50 to transfer the read electric charges in the vertical direction Y.

As described above, according to the solid-state imaging device of this embodiment, the reading pulses are applied to the transfer electrodes V1 and V2, so that the electric charges stored in the photoelectric conversion element 5 adjacent to the left side of the vertical electric charge transfer path 3 and the photoelectric conversion element 4 paired therewith can be mixed together and read to the vertical electric charge transfer path 3 and transferred. The reading pulses are applied to the transfer electrodes V3 and V4, so that the electric charges stored in the photoelectric conversion element 4 adjacent to the right side of the vertical electric charge transfer path 3 and the photoelectric conversion element 5 paired therewith can be mixed together and read to the vertical electric charge transfer path 3 and transferred. Since the detecting sensitivity of the photoelectric conversion element 4 is higher than the detecting sensitivity of the photoelectric conversion element 5, the electric charges are mixed as described above so that a dynamic range can be extended.

Further, the photoelectric conversion element 4 is adjacent to the photoelectric conversion element 5 paired therewith through the electric charge reading section 22 or 23. Since the width of the electric charge reading sections 22 and 23 can be made to be adequately smaller than that of the vertical transfer path 3, a distance between the photoelectric conversion element 4 and the photoelectric conversion element 5 paired therewith is greatly smaller than a distance between the photoelectric conversion elements 4 or the photoelectric conversion elements 5 arranged in the horizontal direction X. That is, since the electric charges obtained in the two photoelectric conversion elements located at very close positions can be mixed together, the two electric charges scarcely having a shift in sampling points can be mixed together. Thus, an image of a good quality can be formed.

Further, in the solid image pick-up element of this embodiment, since one vertical electric charge transfer path 3 is provided relative to the four photoelectric conversion element columns, the number of the vertical electric charge transfer paths 3 can be made to be half as many as the number of the vertical electric charge transfer paths disclosed in JP-A-08-009267. Accordingly, even when the number of pixels is increased, the area of the photoelectric conversion element can be ensured without reducing the width of the vertical electric charge transfer path 3, an electric charge transfer efficiency can be prevented from being deteriorated and the sensitivity can be prevented from being lowered. Further, when the number of pixels is not changed, the area of the photoelectric conversion element can be increased to improve the sensitivity or the area of the vertical electric charge transfer path 3 can be increased to improve the electric charge transfer efficiency.

Further, in the solid-state imaging device of this embodiment, among the pair of the photoelectric conversion elements including the photoelectric conversion element 4 and the photoelectric conversion element 5 paired therewith, the potential of the photoelectric conversion element located at a position remote from the vertical electric charge transfer path 3 corresponding to the pair of the photoelectric conversion elements is designed to be shallower than the potential of the photoelectric conversion element located at a position near the vertical electric charge transfer path. Thus, the electric charge can be smoothly read. For instance, in the photoelectric conversion element 4 and the photoelectric conversion element 5 shown in FIG. 6, the potential of the photoelectric conversion element 4 may be designed to be shallower than the potential of the photoelectric conversion element 5. In the photoelectric conversion element 4 and the photoelectric conversion element 5 shown in FIG. 7, the potential of the photoelectric conversion element 5 may be designed to be shallower than the potential of the photoelectric conversion element 4.

In the structure of the solid-state imaging device of this embodiment, to prevent an electric field concentration as in the first embodiment, timings for applying the reading pulses to the transfer electrode V1 and the transfer electrode V2 may be preferably shifted, and timings for applying the reading pulses to the transfer electrode V3 and the transfer electrode V4 are preferably shifted. Further, to avoid the electric field concentration, the voltage level of the reading pulse applied to the transfer electrode V2 is preferably set to be lower than that of the reading pulse applied to the transfer electrode V1. The voltage level of the reading pulse applied to the transfer electrode V4 is preferably set to be lower than that of the reading pulse applied to the transfer electrode V3.

Further, in the structure of the solid-state imaging device of this embodiment, a detecting difference may not be provided between the photoelectric conversion element 4 and the photoelectric conversion element 5 like the first embodiment.

### Third Embodiment

In the solid-state imaging device of the first embodiment, the photoelectric conversion element 2 is arranged at a position shifted in the obliquely rightward and upward direction from the position of the photoelectric conversion element 1 paired therewith. However, in a solid-state imaging device of this embodiment, the position of the photoelectric conversion element 2 shown in FIG. 1 is arranged at a position shifted in the horizontal direction X from the position of the photoelectric conversion element 1 paired with the photoelectric conversion element 2.

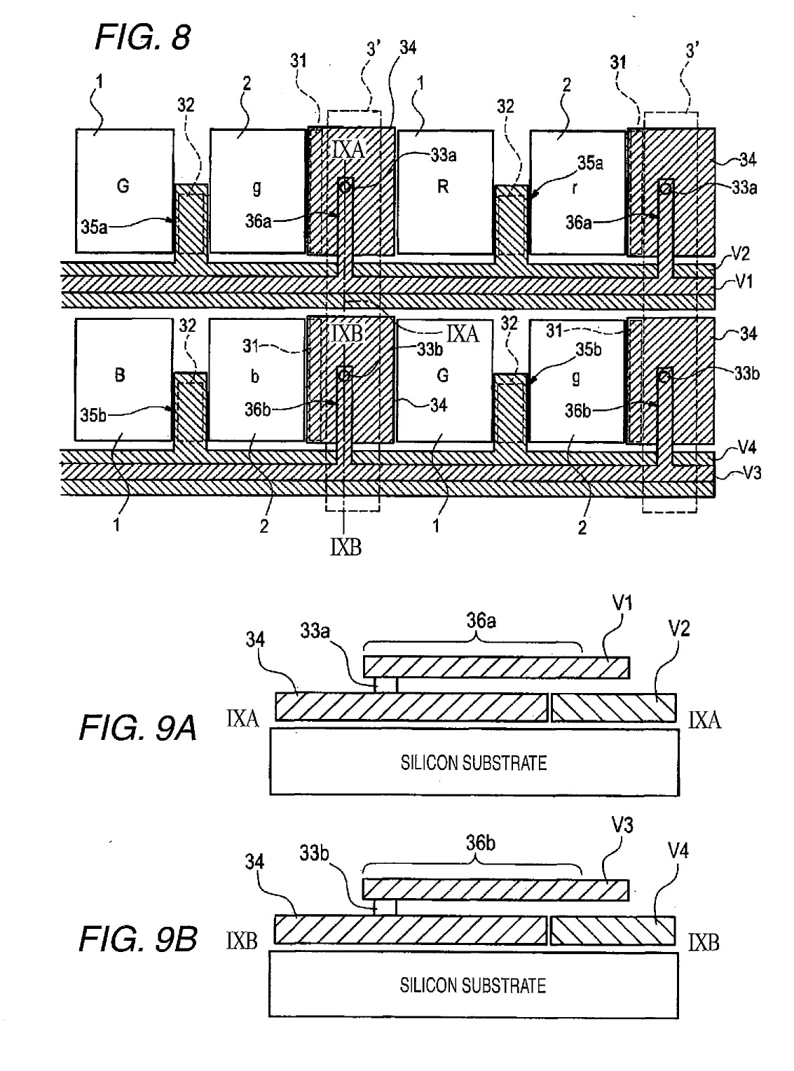

FIG. 8 is a partly enlarged schematic view showing a schematic structure of the solid-state imaging device of a third exemplary embodiment of the present invention. In FIG. 8, structures the same as those of FIG. 1 are designated by the same reference numerals. In FIG. 8, the forms of the photoelectric conversion element 1 and the photoelectric conversion element 2 are different from those of FIG. 1, however, functions thereof are the same. FIG. 9A is a sectional schematic view taken along a line IXA-IXA shown in FIG. 8 and FIG. 9B is a sectional schematic view taken along a line IXB-IXB shown in FIG. 8.

As shown in FIG. 8, the solid-state imaging device of this embodiment has a structure that the photoelectric conversion element 2 paired with the photoelectric conversion element 1 is arranged at a position rightward adjacent to the photoelectric conversion element 1. In the right side of the photoelectric conversion element 2, a vertical electric charge transfer path 3′ is provided for transferring an electric charge stored in the photoelectric conversion element 2 in a vertical direction Y correspondingly to a pair of photoelectric conversion elements including the photoelectric conversion element 2 and the photoelectric conversion element 1 paired therewith. The vertical electric charge transfer path 3, has a linear form extending in the vertical direction Y.

Between the vertical electric charge transfer path 3′ and the photoelectric conversion element 2 corresponding thereto, an electric charge reading section 31 is formed for reading the electric charge stored in the photoelectric conversion element 2 to the vertical electric charge transfer path 3′. Between the photoelectric conversion element 1 and the photoelectric conversion element 2 paired therewith, an electric charge reading section 32 is formed for reading an electric charge stored in the photoelectric conversion element 1 to the photoelectric conversion element 2.

An electrode 34 is formed above between the photoelectric conversion element 1 and the photoelectric conversion element 2 adjacent to each other sandwiching the vertical electric charge transfer path 3, therebetween. The electrode 34 is formed to cover the electric charge reading section 31 and a part of the vertical electric charge transfer path 3′.

Above a lower side part of a GR photoelectric conversion element row including G photoelectric conversion elements 1 and 2 and R photoelectric conversion elements 1 and 2 arranged in the horizontal direction X, a transfer electrode V2 extending in the horizontal direction X is formed correspondingly to the GR photoelectric conversion element row. The transfer electrode V2 has protruding parts 35a protruding above of the electric charge reading sections 32 formed between the photoelectric conversion elements of the GR photoelectric conversion element row corresponding thereto.

On the transfer electrode V2, a transfer electrode V1 extending in the horizontal direction X is formed through an insulating film. The transfer electrode V1 has protruding parts 36a protruding above the electrodes 34 between the photoelectric conversion elements of the GR photoelectric conversion element row corresponding thereto. Between the protruding parts 36a and the electrodes 34, wiring parts 33a are provided for electrically connecting them.

Above a lower side part of a BG photoelectric conversion element row including B photoelectric conversion elements 1 and 2 and G photoelectric conversion elements 1 and 2 arranged in the horizontal direction X, a transfer electrode V4 extending in the horizontal direction X is formed correspondingly to the BG photoelectric conversion element row. The transfer electrode V4 has protruding parts 35b protruding above the electric charge reading sections 32 formed between the photoelectric conversion elements of the BG photoelectric conversion element row corresponding thereto.

On the transfer electrode V4, a transfer electrode V3 extending in the horizontal direction X is formed through an insulating film. The transfer electrode V3 has protruding parts 36b protruding above the electrodes 34 between the photoelectric conversion elements of the BG photoelectric conversion element row corresponding thereto. Between the protruding parts 36b and the electrodes 34, wiring parts 33b are provided for electrically connecting them.

An operation of the solid-state imaging device constructed as described above will be described below. The solid-state imaging device of this embodiment can be also driven by two reading modes of a single reading mode and a mixed reading mode as in the first embodiment.

### (Single Reading Mode)

Initially, when a reading pulse is applied to the transfer electrode V1 by an imaging device driving section 50, a potential barrier formed by the electric charge reading section 31 below the electrode 34 connected to the protruding part 36a of the transfer electrode V1 disappears. Since a potential barrier formed by the electric charge reading section 32 is maintained, the electric charge stored in the photoelectric conversion element 1 of the GR photoelectric conversion element row is not moved to the photoelectric conversion element 2 paired therewith and is held in the photoelectric conversion element 1. On the other hand, the electric charge stored in the photoelectric conversion element 2 of the GR photoelectric conversion element row is read to the vertical electric charge transfer path 3′ via the electric charge reading section 31. After the electric charge is read from the photoelectric conversion element 2, four-phase transfer pulses are applied to the transfer electrodes V1 to V4 by the imaging device driving section 50 to transfer the electric charges in the vertical direction Y.

Then, when a reading pulse is applied to the transfer electrode V3 by the imaging device driving section 50, a potential barrier formed by the electric charge reading section 31 below the electrode 34 connected to the protruding part 36b of the transfer electrode V3 disappears. Since a potential barrier formed by the electric charge reading section 32 is maintained, the electric charge stored in the photoelectric conversion element 1 of the BG photoelectric conversion element row is not moved to the photoelectric conversion element 2 paired therewith and is held in the photoelectric conversion element 1. On the other hand, the electric charge stored in the photoelectric conversion element 2 of the BG photoelectric conversion element row is read to the vertical electric charge transfer path 3′ via the electric charge reading section 31. After the electric charge is read from the photoelectric conversion element 2, four-phase transfer pulses are applied to the transfer electrodes V1 to V4 by the imaging device driving section 50 to transfer the electric charges in the vertical direction Y.

### (Mixed Reading Mode)

Initially, when the reading pulses are applied to the transfer electrode V1 and the transfer electrode V2 by the imaging device driving section 50, the potential barriers of the electric charge reading sections 31 and 32 below the transfer electrodes V1 and V2 disappear. Accordingly, the electric charge stored in the photoelectric conversion element 1 of the GR photoelectric conversion element row is read to the photoelectric conversion element 2 via the electric charge reading section 32 and mixed with the electric charge stored in the photoelectric conversion element 2. Then, the mixed electric charges of the electric charge read from the photoelectric conversion element 1 and the electric charge originally stored in the photoelectric conversion element 2 are read to the vertical electric charge transfer path 3′ via the electric charge reading section 31. After the electric charges are read from the photoelectric conversion element 2, four-phase transfer pulses are applied to the transfer electrodes V1 to V4 by the imaging device driving section 50 to transfer the electric charges in the vertical direction Y.

Then, when the reading pulses are applied to the transfer electrode V3 and the transfer electrode V4 by the imaging device driving section 50, the potential barriers of the electric charge reading sections 31 and 32 below the transfer electrodes V3 and V4 disappear. Accordingly, the electric charge stored in the photoelectric conversion element 1 of the BG photoelectric conversion element row is read to the photoelectric conversion element 2 via the electric charge reading section 32 and mixed with the electric charge stored in the photoelectric conversion element 2. Then, the mixed electric charges of the electric charge read from the photoelectric conversion element 1 and the electric charge originally stored in the photoelectric conversion element 2 are read to the vertical electric charge transfer path 3′ via the electric charge reading section 31. After the electric charges are read from the photoelectric conversion element 2, four-phase transfer pulses are applied to the transfer electrodes V1 to V4 by the imaging device driving section 50 to transfer the electric charges in the vertical direction Y.

As described above, according to the solid-state imaging device of this embodiment, the same effects as those of the solid-state imaging device of the first embodiment can be obtained. In the case of the arrangements of the photoelectric conversion elements described in the first embodiment and the second embodiment, the area occupied by the vertical electric charge transfer path 3 in one cell is large. In order to increase the area of the photoelectric conversion element and improve sensitivity, the vertical electric charge transfer path is ordinarily reduced to apply a space produced thereby to the photoelectric conversion element. However, since the area of the vertical electric charge transfer path is greatly related to the electric charge transfer efficiency, the vertical electric charge transfer path cannot be simply reduced. Since the number of the vertical electric charge transfer paths can be decreased, the present invention is especially effective in the solid-state imaging device with the arrangement of the photoelectric conversion elements in which the area of the vertical electric charge transfer path is hardly reduced.

### Fourth Embodiment

A solid-state imaging device of a fourth exemplary embodiment of the present invention is a modified example of the solid-state imaging device shown in FIG. 8.

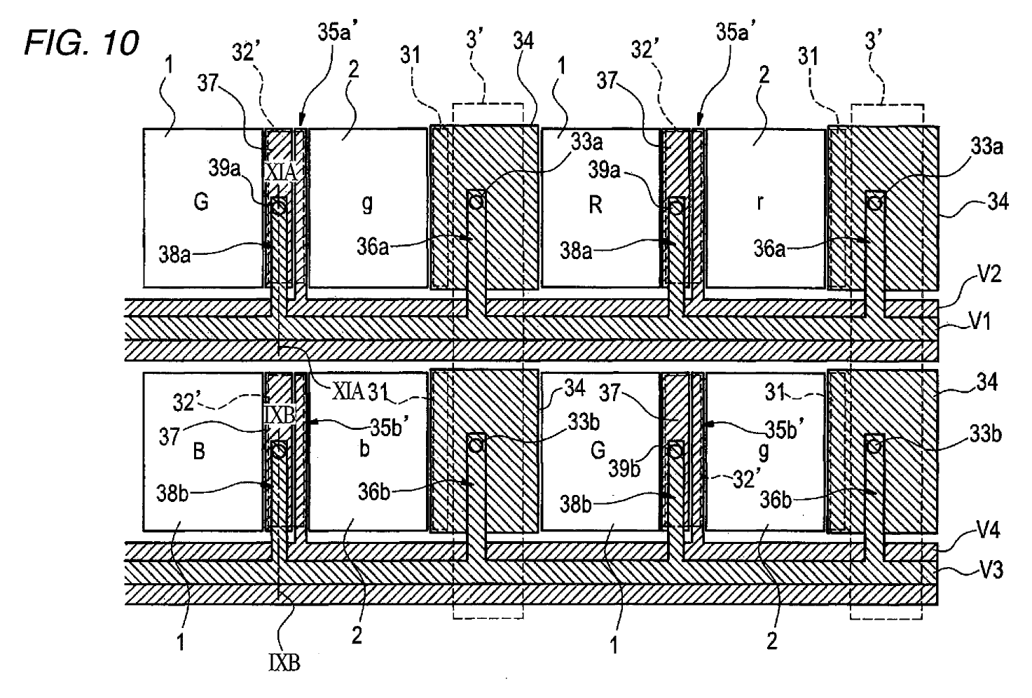

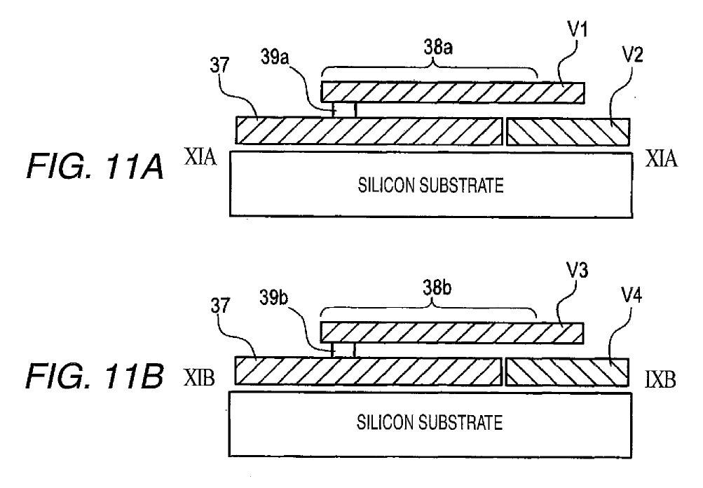

FIG. 10 is a partly enlarged schematic view showing a schematic structure of the solid-state imaging device of the fourth embodiment of the present invention. In FIG. 10, structures the same as those of FIG. 8 are designated by the same reference numerals. FIG. 11A is a sectional schematic view taken along a line XIA-XIA shown in FIG. 10 and FIG. 11B is a sectional schematic view taken along a line XIB-XIB shown in FIG. 10.

In the solid-state imaging device shown in FIG. 10, the area of the electric charge reading section 32 shown in FIG. 8 is increased to have an electric charge reading section 32′. In a transfer electrode V2, a protruding part 35a′ is provided that protrudes above a part of the electric charge reading section 32′. An electrode 37 is provided above a part of the electric charge reading section 32′ that is not overlapped on the protruding part 35a′. In a transfer electrode V1, a protruding part 38a is provided that protrudes above the electrode 37. Between the protruding part 38a and the electrode 37, wiring 39a is formed for electrically connecting them.

In a transfer electrode V4, a protruding part 35b′ is provided that protrudes above a part of the electric charge reading section 32′. An electrode 37 is provided above a part of the electric charge reading section 32′ that is not overlapped on the protruding part 35b′. In a transfer electrode V3, a protruding part 38b is provided that protrudes above the electrode 37. Between the protruding part 38b and the electrode 37, wiring 39b is formed for electrically connecting them.

An operation of the solid-state imaging device constructed as described above will be described below. The solid-state imaging device of this embodiment can be also driven by two reading modes of a single reading mode and a mixed reading mode as in the first embodiment.

### (Single Reading Mode)

Initially, when a reading pulse is applied to the transfer electrode V1 by an imaging device driving section 50, a potential barrier formed by an electric charge reading section 31 below an electrode 34 connected to the protruding part 36a of the transfer electrode V1 disappears, and a potential barrier of the electric charge reading section 32′ below the electrode 37 disappears. Since a potential barrier formed by the electric charge reading section 32′ below the protruding part 35a′ is maintained, an electric charge stored in a photoelectric conversion element 1 of a GR photoelectric conversion element row is not moved to a photoelectric conversion element 2 paired therewith and is held in the photoelectric conversion element 1. On the other hand, the electric charge stored in the photoelectric conversion element 2 of the GR photoelectric conversion element row is read to a vertical electric charge transfer path 3′ via the electric charge reading section 31. After the electric charge is read from the photoelectric conversion element 2, four-phase transfer pulses are applied to the transfer electrodes V1 to V4 by the imaging device driving section 50 to transfer the electric charges in the vertical direction Y.

Then, when a reading pulse is applied to the transfer electrode V3 by the imaging device driving section 50, a potential barrier formed by the electric charge reading section 31 below the electrode 34 connected to a protruding part 36b of the transfer electrode V3 disappears, and a potential of the electric charge reading section 32′ below the electrode 37 disappears. Since a potential barrier formed by the electric charge reading section 32′ below the protruding part 35b′ is maintained, an electric charge stored in a photoelectric conversion element 1 of a BG photoelectric conversion element row is not moved to a photoelectric conversion element 2 paired therewith and is held in the photoelectric conversion element 1. On the other hand, the electric charge stored in the photoelectric conversion element 2 of the BG photoelectric conversion element row is read to the vertical electric charge transfer path 3′ via the electric charge reading section 31. After the electric charge is read from the photoelectric conversion element 2, four-phase transfer pulses are applied to the transfer electrodes V1 to V4 by the imaging device driving section 50 to transfer the electric charges in the vertical direction Y.

### (Mixed Reading Mode)

Initially, when the reading pulses are applied to the transfer electrode V1 and the transfer electrode V2 by the imaging device driving section 50, the potential barriers of the electric charge reading sections 31 and 32′ below the electrode 34, the electrode 37 and the protruding part 35a′ disappear. Accordingly, the electric charge stored in the photoelectric conversion element 1 of the GR photoelectric conversion element row is read to the photoelectric conversion element 2 via the electric charge reading section 32′ and mixed with the electric charge stored in the photoelectric conversion element 2. Then, the mixed electric charges of the electric charge read from the photoelectric conversion element 1 and the electric charge originally stored in the photoelectric conversion element 2 are read to the vertical electric charge transfer path 3′ via the electric charge reading section 31. After the electric charges are read from the photoelectric conversion element 2, four-phase transfer pulses are applied to the transfer electrodes V1 to V4 by the imaging device driving section 50 to transfer the electric charges in the vertical direction Y.

Then, when the reading pulses are applied to the transfer electrode V3 and the transfer electrode V4 by the imaging device driving section 50, the potential barriers of the electric charge reading sections 31 and 32′ below the electrode 34, the electrode 37 and the protruding part 35b′ disappear. Accordingly, the electric charge stored in the photoelectric conversion element 1 of the BG photoelectric conversion element row is read to the photoelectric conversion element 2 via the electric charge reading section 32′ and mixed with the electric charge stored in the photoelectric conversion element 2. Then, the mixed electric charges of the electric charge read from the photoelectric conversion element 1 and the electric charge originally stored in the photoelectric conversion element 2 are read to the vertical electric charge transfer path 3′ via the electric charge reading section 31. After the electric charges are read from the photoelectric conversion element 2, four-phase transfer pulses are applied to the transfer electrodes V1 to V4 by the imaging device driving section 50 to transfer the electric charges in the vertical direction Y.

Also in the structure of this embodiment, the same effects as those of the first embodiment can be obtained. In order to avoid an electric field concentration in the mixed reading mode, timings for applying the reading pulses to the transfer electrodes V1 and V2 may be preferably shifted or the voltage level of the reading pulse applied to the transfer electrode V1 is preferably set to be lower than that of the reading pulse applied to the transfer electrode V2. Similarly, to avoid the electric field concentration in the mixed reading mode, timings for applying the reading pulses to the transfer electrodes V3 and V4 are preferably shifted, or the voltage level of the reading pulse applied to the transfer electrode V3 is preferably set to be lower than that of the reading pulse applied to the transfer electrode V4.

What is claimed is:

1. A solid-state imaging device comprising:
a plurality of pairs of photoelectric conversion elements, each pair including a first photoelectric conversion element and a second photoelectric conversion element which are adjacent to each other;
a charge transfer path that is disposed adjacently to the first photoelectric conversion element and that transfers in a first direction an electric charge stored in the first photoelectric conversion element;
a first charge reading section that is disposed between the charge transfer path and the first photoelectric conversion element and that reads the electric charge stored in the first photoelectric conversion element to the charge transfer path; and
a second charge reading section that is disposed between the first photoelectric conversion element and the second photoelectric conversion element and that reads an electric charge stored in the second photoelectric conversion element to the first photoelectric conversion element.

2. The solid-state imaging device according to claim 1, wherein
the plurality of pairs of photoelectric conversion elements are arranged in such a way that a first photoelectric conversion element column including a plurality of first photoelectric conversion elements arranged in the first direction and a second photoelectric conversion element column including a plurality of second photoelectric conversion elements disposed adjacent to the respective first photoelectric conversion elements and arranged in the first direction are alternately arranged in a second direction perpendicular to the first direction, wherein the first photoelectric conversion element column and the second electric conversion element column which are continuously arranged in the second direction constitute a set of element column, and
the electric charge transfer path is disposed correspondingly in a side part of the set of element column.

3. The solid-state imaging device according to claim 2, wherein the second photoelectric conversion element is arranged at a position shifted from a position of the first photoelectric conversion element to a direction intersecting each of the first direction and the second direction.

4. The solid-state imaging device according to claim 1, wherein
the plurality of pairs of photoelectric conversion elements are arranged in such a way that a first photoelectric conversion element column including a plurality of first photoelectric conversion elements arranged in the first direction and a second photoelectric conversion element column including a plurality of second photoelectric conversion elements disposed adjacent to the respective first photoelectric conversion elements and arranged in the first direction are alternately arranged in a second direction perpendicular to the first direction, wherein four photoelectric conversion element columns which include two first photoelectric conversion element columns and two second electric conversion element columns and which are continuously arranged in the second direction constitute a set of element column, and
the electric charge transfer path is disposed correspondingly to the set of element column and between the first photoelectric conversion element column and the second photoelectric conversion element column which are not the first photoelectric conversion element column and the second photoelectric conversion element column at both ends of the set of element column.

5. The solid-state imaging device according to claim 4, wherein when a position of the first photoelectric conversion element in each pair of photoelectric conversion elements included in the four photoelectric conversion element columns constituting the set of element column is set to a reference position, the second photoelectric conversion element of a pair of photoelectric conversion elements located in one side of the electric charge transfer path are disposed at a position shifted from the reference position in a direction different from that of the second photoelectric conversion element of a pair of photoelectric conversion elements located in the other side of the electric charge transfer path.

6. The solid-state imaging device according to claim 5, wherein the direction from the reference position with respect to the second photoelectric conversion element of the pair of photoelectric conversion elements located in the one side of the electric charge transfer path is perpendicular to the direction from the reference position with respect to the second photoelectric conversion element of the pair of photoelectric conversion elements located in the other side of the electric charge transfer path.

7. The solid-state imaging device according to claim 1, wherein the second photoelectric conversion element has a potential shallower than that of the first photoelectric conversion element.

8. The solid-state imaging device according to claim 7, wherein the second photoelectric conversion element has an area smaller than that of the first photoelectric conversion element.

9. The solid-state imaging device according to claim 1, wherein the first and second photoelectric conversion elements have different sensitivity for detecting light.

10. The solid-state imaging device according to claim 9, wherein the first photoelectric conversion element detects light having the same wavelength area as that of light detected by the second photoelectric conversion element.

11. The solid-state imaging device according to claim 1, further comprising a plurality of electrodes arranged above the second charge reading section and in a direction where the pair of photoelectric conversion elements are arranged, wherein a voltage can be independently applied to each of the plurality of electrodes.

12. An imaging apparatus comprising:
a solid-state imaging device according to claim 11; and
a voltage applying unit that applies a voltage to the plurality of electrodes, wherein the voltage applying unit shifts a timing for applying the voltage to the plurality of electrodes to move an electric charge from the second photoelectric conversion element to the first photoelectric conversion element.

13. The imaging apparatus according to claim 12, wherein the voltage applying unit applies a lower voltage to an electrode of the plurality of electrodes as the electrode is nearer to the second photoelectric conversion element.

14. An imaging apparatus comprising:
a solid-state imaging device according to claim 11; and
a voltage applying unit that applies a voltage to the plurality of electrodes, wherein the voltage applying unit applies a lower voltage to an electrode of the plurality of electrodes as the electrode is nearer to the second photoelectric conversion element.

15. An imaging device comprising a solid-state imaging device according to claim 1.
